(19) United States
(12) Patent Application Publication
(10) Pub. No.: US 2017/0050702 A1
(43) Pub. Date: Feb. 23, 2017

(54) DERAILLEUR SHIFTING SYSTEM

(71) Applicants: Michael J. Grassi, Columbus, OH (US); Charles Rizzuti, Martinez, CA (US)

(72) Inventors: Michael J. Grassi, Columbus, OH (US); Charles Rizzuti, Martinez, CA (US)

(73) Assignee: Dyno Pro LLC, Brooklyn, OH (US)

(21) Appl. No.: 15/242,250

(22) Filed: Aug. 19, 2016

Related U.S. Application Data
(60) Provisional application No. 62/207,699, filed on Aug. 20, 2015.

(51) Int. Cl. B62M 25/08; B62K 23/02

(52) U.S. Cl. CPC B62M 25/08; B62K 23/02; B62M 2025/003

(57) ABSTRACT

A derailleur shifting system for electronic and mechanical derailleurs which may be upgradeable to a power meter is described having rider inputs for cadence and effort measured at the pedal-crank assembly.

### BACKGROUND

The present exemplary embodiments relate to apparatus for shifting gears in a bicycle derailleur system. The present exemplary embodiments find particular application in conjunction with a pedal-crank based force/torque measuring system for human-propelled vehicles such as bicycles. However, it is to be appreciated that the present exemplary embodiments are also amenable to other like applications.

Modern derailleur systems for bicycles are able to shift electronically, improving shifting by permitting faster chain movement, more precise movement of the chain, while removing the wear of a mechanical cable. Also eliminated is cable stretch which itself is a nuisance issue when shifting and maintaining a bike, as the stretch over time causes the chain not to shift correctly. For the user, electronic shifting permits a lower hand operating force on the shifter itself, especially for the front derailleur, making for an easier to operate derailleur system.

Much of this technology has actually been anticipated for some time, as Mavic of France introduced an electronic derailleur in the early 1990's, the ZMS Zap Mavic System. Campagnolo of Italy also has an electronic derailleur. In the same regard, automatic transmissions for bicycle shifting has also been discussed for some time, including designs which are continuously variable transmission (CVT) related such as the NuVinci® N360 rear hub and shift system which entirely replaces the chain sprocket derailleur system. This is offered by Fullbrook Technologies of Cedar Park, Tex. Most of the discussions of automatic shifting on web-based forums focus on concepts that would be controlled as a torque-constant and RPM-constant type shifting systems. Other concepts discussed have been based on using GPS where geography is known and speed can be used to shift as well. Recently, a product that has been shown in the market is a system called BioShift by Baron Biosystems of Toronto, Canada. While proprietary algorithms are used, the system works by gathering cadence (RPM) and wattage values wirelessly, and then using this data along with information such as rider weight that is programmed into the system and the gears on the bike to automatically shift the derailleurs. Most important, the user has no control of the shifting process, other than to manually override the system. In essence the system is a black box. The system requires a power meter to work, as the data used to control shifting comes from a power meter. Power meters can be very costly and the majority of cyclists do not have electronic derailleurs as of yet, and if so, only a small subset of these cyclists own a power meter, as power meters are fairly expensive.

The majority of bicycles have mechanical derailleurs and shift operators for these derailleurs. Other than indicators as to what gear/position the derailleur is in, there is nothing to tell the rider when to shift or what gear they should be in. The vast majority of riders, especially those that do not race, have no need for or use for power measurement. These riders therefore do not own a power meter, nor are they ever likely to buy a power meter. These riders are mostly recreational riders. Internal market studies have found that these types of riders find having to shift a bit confusing (especially when two derailleurs are involved) and this class of rider would benefit from a derailleur shifting system. This class of rider has also expressed the view that they do not even understand when they are supposed to shift let alone how often unless a large gradient forces the issue by significantly slowing the rider down. The matter of shifting for most riders is thus somewhat of a mystery, with the rider never really knowing if they are in the optimum gear, especially when two derailleurs are present and the choice of gearing is double.

There thus is a need for a low cost derailleur shifting system that has the ability to either send a signal to the rider or to the derailleur system if electronic but that does not require the use of a power meter per se.

### BRIEF DESCRIPTION

In accordance with one embodiment, there is provided a system that generates a shift signal for any of mechanical derailleurs, wired electronic derailleurs, or wireless electronic derailleurs. The system is modular, in that a force/torque sensor can be employed even if not calibrated to a standard force/torque. The force/torque sensor can later be upgraded to a power meter which requires calibration to a known standard force/torque.

In accordance with another embodiment, a derailleur shifting system includes an effort reader removably attached to a crank arm of an associated bicycle, the effort reader communicatively coupled to a force sensor. The system further includes an RPM sensor, and a derailleur shifting control system in communication with at least one of a front derailleur, a rear derailleur and a shift indicator. The derailleur shifting control system receives a force amount from the effort reader and a current RPM from the RPM sensor to generate a shift signal to the at least one of the front derailleur, the rear derailleur, and the shift indicator.

According to another embodiment, a method for controlling derailleur shifting on an associated bicycle includes the steps of receiving a cadence setting corresponding to a selected RPM into a first microcontroller, and receiving an effort setting corresponding to a force applied to a crank of the associated bicycle into the first microcontroller. The method also includes transmitting, from an associated RPM sensor to the first microcontroller, a current RPM of the associated bicycle, and communicating, from an associated force sensor to a second microcontroller communicatively coupled thereto, an amount of force currently applied to the crank of the associated bicycle. In addition, the method includes transmitting the current amount of force from the second microcontroller to the first microcontroller, and determining, in accordance with the current RPM and current amount of force by the first microcontroller, whether to generate a shift signal indicative of a gear change of the associated bicycle. Thereafter, the method includes generating, by the first microcontroller, the shift signal in accordance with the determination, wherein the shift signal comprises at least one of an audible alert, a visual alert, or a wireless signal to an associated derailleur to change a current gear.

According to yet another embodiment, a method for controlling derailleur shifting on an associated bicycle includes receiving a cadence setting corresponding to a selected RPM into a first microcontroller, and receiving an effort setting corresponding to a force applied to a crank of the associated bicycle into the first microcontroller. The method also includes communicating, from an associated torque sensor to a second microcontroller communicatively coupled thereto, an amount of torque currently applied to the crank of the associated bicycle, and transmitting the current amount of torque from the second microcontroller to the first microcontroller. The method further includes calculating, from the current amount of torque, a cadence corresponding to a current RPM (thereby eliminating the need for a separate cadence sensor or component for cadence measurement such as an accelerometer, gyrometer, or the like), and determining, in accordance with the current RPM and current amount of force by the first microcontroller, whether to generate a shift signal indicative of a gear change of the associated bicycle. The method also includes generating, by the first microcontroller, the shift signal in accordance with the determination, wherein the shift signal comprises at least one of an audible alert, a visual alert, or a wireless signal to an associated derailleur to change a current gear.

### BRIEF DESCRIPTION OF THE DRAWINGS

FIG. 1 is a block diagram of a derailleur shifting system according to one embodiment of the present disclosure;

FIG. 2 is a graph showing force sensor output and data showing that cadence can be measured from the sensor output of the system of FIG. 1.

FIG. 3 is a flowchart showing operations of the derailleur shifting system according to one embodiment of the present disclosure.

### DETAILED DESCRIPTION

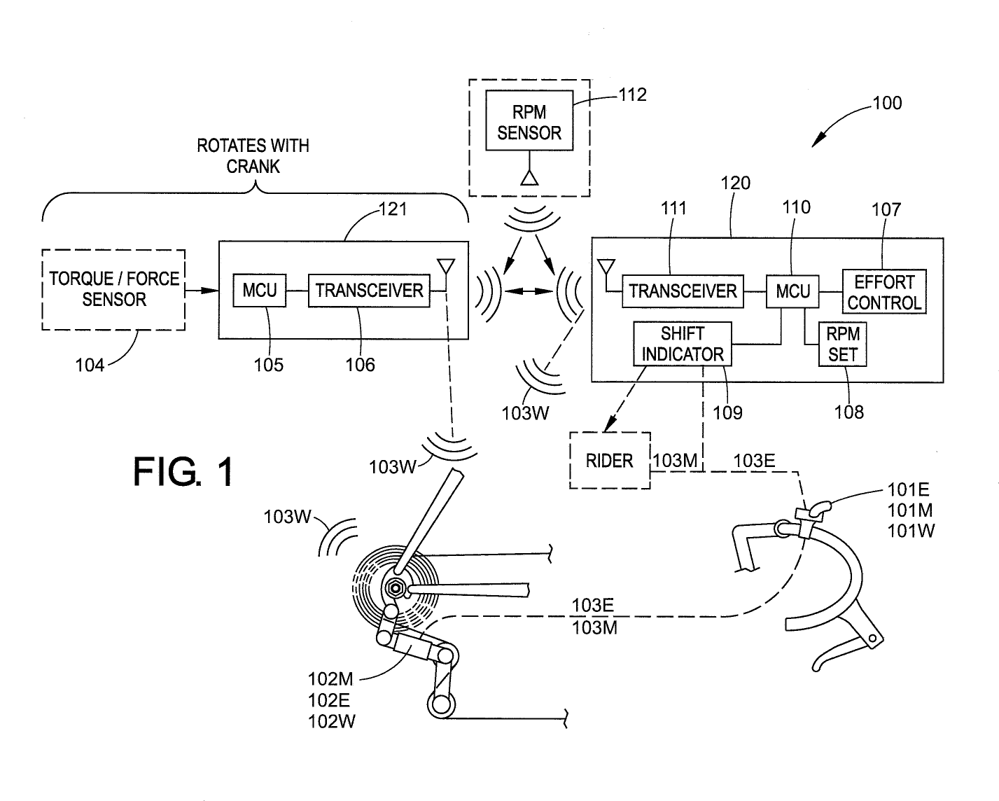

FIG. 1 shows a schematic diagram of the derailleur shifting system 100. The system 100 is described for just one derailleur, however, this can be extended to a bike having a two derailleur system.

It should be appreciated that the derailleur can be a rear derailleur or a front derailleur as both are well known and commonly used for a variety of bicycles from road bikes to mountain bikes to racing bikes.

In this description, an associated derailleur shifter is shown as 101E. This derailleur shifter typically takes the form of a manual electronic switch that causes a motor in a derailleur 102E to shift with a control 103E which is an electronic signal. For a mechanical type derailleur shifter 101M, the derailleur 102M is switched using control 103M which is a mechanical cable. A control 103W which is a wireless signal that can be sent directly to a wireless motorized derailleur 102W is also possible with this system. In the embodiment shown, the associated derailleur 102M, 102E, 102W, the derailleur shifter 101E, 101M, 101W need not be modified for this derailleur shifting system 100.

FIG. 1 shows an associated force/torque sensor 104. An example of such a sensor is that of U.S. Pat. No. 9,097,598 which fits inside a hollow crank spindle. The subject matter of that patent is incorporated hereinto in its entirety. Other sensors that can measure force such as strain gage that can be mounted to a pedal or crank arm can also be used. The sensor described in U.S. Pat. No. 9,097,598 is of particular advantage as that sensor can be removable. That sensor, or a like sensor, measures torque and is directly applicable to the present embodiment.

Using such a sensor 104, a power meter is not required for automatic shifting. Rather the sensor 104 presents itself as a lower cost alternative to a power meter that can be added to an existing associated bicycle having a derailleur. The derailleur shifting system 100 is composed of an effort reader/controller 121 and derailleur shifting system control 120. In one embodiment, effort reader/controller 121 rotates with a crank-pedal system, requiring the system 100 to be wireless. Sensor 104 however need not be calibrated like that of power meter.

The derailleur shifting system 100 as shown in FIG. 1, functions by rider input to an ‘effort’ control 107, which can be an adjustable input controlled during riding by a knob, throttle, lever, up-down (+/−) switch, or the like, or by an audible detector such a microphone or the like; but which allows the user to adjust a control similar to the volume control of radio, or the acceleration or speed of a car. That is, effort control 107 allows a relative input from a first signal setting. The derailleur system 100 also functions by rider input to an rpm setter 108 similar or like that described for control 107 and from associated sensor 104 as will now be described.

The rider inputs their desired cadence into the RPM setter 108, which is part of derailleur shifting system control 120. Although this can be done with a display and keypad, an adjustable input controlled during riding by a knob, throttle, lever, up-down (+/−) switch, or the like can be used as the rider brings the associated crank-pedal system up to the desired cadence (riders have different desired cadences) thereby setting the desired cadence (within a +/− range controlled by the gearing of the bicycle) being read by associated rpm sensor 112 or the like. Once the cadence is set, the ‘effort’ control 107 is used to set the rider's effort. Effort in this schema is measured from the force/torque applied to the crank during cycling and which is sensed by the associated force/torque sensor 104 by microcontroller 105. Thus, the derailleur shifting system in this embodiment uses input from both cadence and effort. Since the force/torque sensor measures rider's pushing force (which is a relative measurement), the sensor 104 need not be calibrated like that required in a power meter. Rather the rider's weight can be used itself as a means of setting a percentage of the rider's force on the pedal. Thus, once cadence is set, the setting of the effort control 107 will be used to compute the shift signal 109.

In accordance with one embodiment, a microcontroller 105 (MCU) located in the pedal crank assembly can be used to indicate when to shift at shift indicator 109, or create shift signal 103M, 103E, 103W as will be shown. Alternatively, microcontroller 110 can be used. Microcontroller (or equivalent) 110 reads effort control 107 signal and transmits this level via transceiver 111 to transceiver 106, whereby microcontroller 105 is used to compute when to shift based on effort sensor's relative value 104, and either directly sends a shift signal 103W in the case of a wireless derailleur 102W, or sends back to transceiver 111, whereby microcontroller 110 generates a shift signal 103W. In the case of a wired electronic derailleur 102E, a shift signal 103E is generated by MCU 110. In the case of a mechanical derailleur 102M, MCU 110 generates a shift signal 103M which indicates to the rider that the rider needs to manually shift derailleur operator 101M. Alternatively, MCU 105 sends effort data via transceiver 106 to transceiver 111; and MCU 110 does all necessary calculations to generate a shift signal 103W, 103E, 103M.

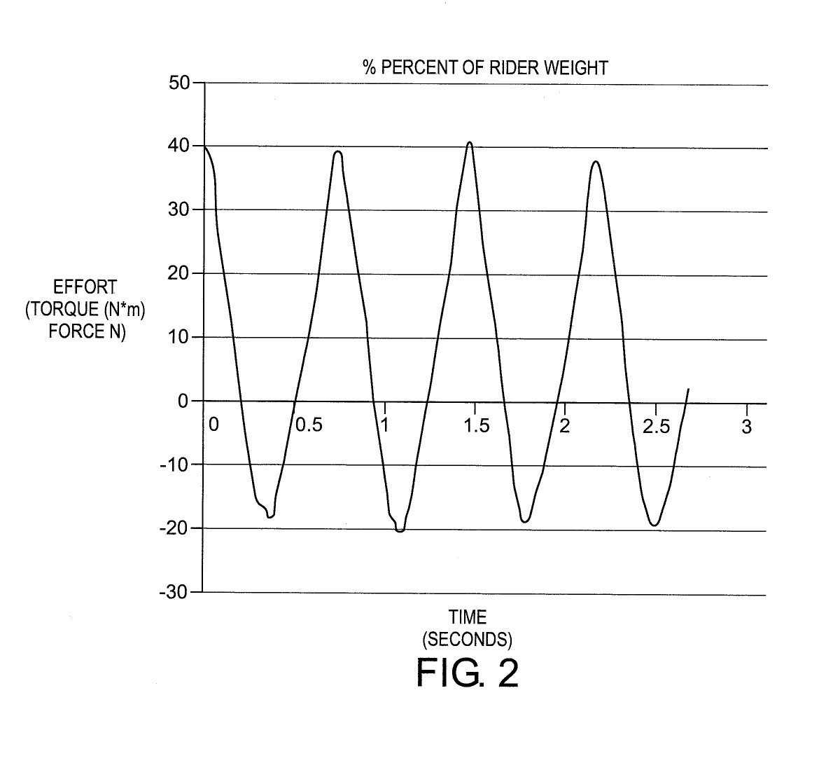

The system 100 will indicate/shift based on the input from both the rpm sensor 112 and the force/torque sensor 104 to maintain both the desired rider's effort and RPM. Although as previously described, RPM setter 108 is used by the rider to set the cadence (RPM), however the RPM need not come from an external associated cadence sensor 112. For example, if a sensor such as that described by U.S. Pat. No. 9,097,598 is used, FIG. 2 shows that during riding, the effort from the torque sensor will oscillate between a maximum and minimum and using MCU's 105 internal clock to measure time between peaks, the cadence can be measured and calculated. Thus data from the force/torque sensor 104 itself can be used to detect the cadence, and that cadence used to control the effort.

In addition, the system 100 permits adding control for cadence (RPM) to the system as the system's design is meant to be modular. As shown, the cadence can come from an associated cadence/speed sensor 112 such as those sold by Garmin, one example being the Garmin® GSC-10 speed cadence bike sensor. Such sensors are commonly used. These RPM sensors 112 are typically wireless and thus the rpm data can be sent to either microcontroller 105 or 110 for purposes of calculation as previously described via transceivers 106, 111. The following embodiment can be used with either mechanical 102M or electronic derailleurs 102W, 102E, or the combination of both. For example, for a mechanical shifting derailleur 102M, a shift indicator 109 such as an LED indicator, or an audible tone, can be as a means to indicate to the rider to shift the derailleur 102M including in which direction to shift the derailleur 102M. If the derailleur is electronic 102E, the shift indicator 109 can be used to indicate a shift is eminent.

The core embodiment is as shown. As just described, additional components or switches may be added to the derailleur shift system controller 120 to permit overriding the system if the signal shift 103E is undesired at the time of riding. The system allows on the fly adjustment of the rpm by setting the rpm setting 108 as well as by setting the effort through the effort control 107. In addition to providing a more user friendly system for being able to shift a bicycle derailleur system, the system provides feedback for shifting as the rider's effort is being measured, and which cannot be done without a force sensor. Thus although a power meter may be an ideal sensor for shifting purposes, this embodiment reduces the requirements to permit a force/torque to be used. Here again the advantage of this is that if a removable force/torque sensor can be used, then a bicycle can be modified to have a derailleur shifting system without the need for additional expensive components. The system as described will permit a rider to be able to determine when to shift a mechanical derailleur, and if an electronic derailleur, can be used to shift the derailleur. Further, especially on hills, the force/torque sensor's 104 input to the effort-reader/controller 121 can be used to maintain the effort at the crank-pedal assembly within the ability of the gearing of the bicycle. The system also can be upgraded. Depending on the quality of sensor 104 used, the system can be sold as a derailleur shifting system, however at a later day it is quite conceivable the effort-reader/controller electronics 121 can be updated and the sensor 104 calibrated to provide a power meter if the user so chooses. Thus, rather than first having to purchase a power meter, the rider can first buy the derailleur shifting system, and then later upgrade the derailleur shifting system to be a power meter as well.

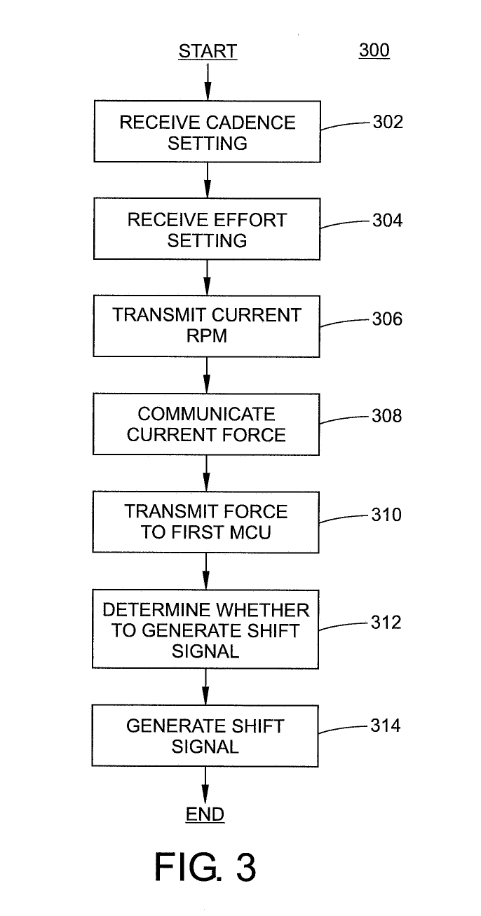

Turning now to FIG. 3, there is shown a flowchart 300 illustrating operations of the derailleur shifting system 100 in accordance with one embodiment of the subject application. As depicted in FIG. 3, the method begins at 302, whereupon a cadence setting corresponding to a selected RPM 108 is received by a first microcontroller, i.e., the MCU 110. As previously discussed, the RPM 108 is representative of the number of rotations of the bicycle crank per minute, i.e., the number of times a rider pedals. At 304, an effort setting corresponding to a force applied to a crank of the associated bicycle is received into the first microcontroller. In accordance with one embodiment, the effort control 107 of the derailleur shift control system 120 may be user adjustable or determined in accordance with other factors, e.g., height/weight/pulse, etc., of the rider, or the like.

An RPM or cadence sensor 112 then transmits the current RPMs of the bicycle to the MCU 110 at 306. An amount of force currently being applied to the crank of the bicycle is detected by torque/force sensor 104 and communicated to a second microcontroller, i.e., the MCU 105 located on the crank arm at 308. The current amount of force is then transmitted from the second microcontroller MCU 105 via the transceiver 106 to the transceiver 111 in communication with the first microcontroller MCU 110 at 310.

The first microcontroller MCU 110 then determines, at 312, whether a shift signal 103W, 103E, 103M is to be generated in accordance with the received current RPM and current amount of force corresponding to a gear change needed on the bicycle. It will be appreciated that the shift signal 103W, 103E, 103M may correspond to a signal to change a gear up or down on either a front derailleur (not shown), or a rear derailleur 102W, 102E, 102M. Accordingly, at 314, a shift signal 103W is generated by the first microcontroller MCU 110 based upon the determination at 312, whereupon the shift signal 103W, 103E, 103M corresponds to an audible alert, a visual alert, or a wireless or electric signal to an associated derailleur to change a current gear. As discussed in greater detail above, the shift signal 103W, 103E when the system 100 is paired with electronic derailleurs (102W, 102E), may include instructions to the derailleur(s) 102W, 102E to change gears on the bicycle, without user intervention. Conversely, when the system 100 is paired with mechanical derailleurs 102M, the shift signal 103M may be communicated to a shift indicator 109 or other bicycle computer (not shown), which prompts the rider to manually change gears in the desired direction, i.e., via activation of the shifter 101E, 101M, 101W.

The method illustrated in FIG. 3 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 3, can be used to implement the method estimating origins and destinations for users of a transportation system.

The present disclosure has been described with reference to the preferred embodiments. Obviously, modifications and alterations will occur to others upon reading and understanding the preceding detailed description. It is intended that the recent disclosure be construed as including all such modifications and alterations insofar as they come within the scope of the appended claims or the equivalents thereof.

1. A derailleur shifting system, comprising:
an effort reader attached to a crank arm of an associated bicycle, the effort reader communicatively coupled to a force sensor;
an RPM sensor; and
a derailleur shifting control system communicatively coupled to the effort reader and the RPM sensor, and with at least one of a front derailleur, a rear derailleur and a shift indicator,
wherein the derailleur shifting control system receives a force amount from the effort reader and a current RPM from the RPM sensor to generate a shift signal to the at least one of the front derailleur, the rear derailleur, and the shift indicator.

2. The system of claim 1, wherein the effort reader further comprises:
a microcontroller; and
a transceiver in communication with the microcontroller, the transceiver wirelessly communicating with the RPM sensor and the force sensor.

3. The system of claim 2, wherein the derailleur shifting control system further comprises:
a microcontroller;
the shift indicator operable in accordance with instructions received from the microcontroller;
a transceiver in communication with the microcontroller, the transceiver wirelessly communicating with the effort reader and the RPM sensor; and
at least one adjustable setting component selected from an effort control and an RPM setter.

4. The system of claim 3, wherein the shift indicator is selected from the group consisting of a speaker and a display.

5. The system of claim 3, wherein the derailleur shifting control system is in wireless communication with at least one of the front derailleur and the rear derailleur.

6. The system of claim 3, wherein the microcontroller of the derailleur shifting control system further comprises a processor in communication with memory, the memory storing instructions, which are executed by the processor to:
receive the at least one adjustable setting component selected from an effort control and an RPM set;
receive a current force amount from the force sensor and a current RPM from the RPM sensor;
determine, in accordance with the current RPM and current amount of force, whether to generate a shift signal indicative of a gear change of the associated bicycle; and
responsive to the determination to generate a shift signal, transmitting the shift signal to at least one of the front derailleur, the rear derailleur, and the shift indicator.

7. The system of claim 6, wherein the force sensor is attached to a crank arm of the associated bicycle.

8. The system of claim 7, wherein the force sensor is a torque sensor positioned inside a hollow interior of the crank arm of the associated bicycle.

9. A method for controlling derailleur shifting on an associated bicycle, comprising:
receiving a cadence setting corresponding to a selected RPM into a first microcontroller;
receiving an effort setting corresponding to a selected force applied to a crank of the associated bicycle into the first microcontroller;
transmitting, from an associated RPM sensor to the first microcontroller, a current RPM of the associated bicycle;
communicating, from an associated force sensor to a second microcontroller communicatively coupled thereto, an amount of force currently applied to the crank of the associated bicycle;
transmitting the current amount of force from the second microcontroller to the first microcontroller;
determining, in accordance with the current RPM and current amount of force by the first microcontroller, whether to generate a shift signal indicative of a gear change of the associated bicycle; and
generating, by the first microcontroller, the shift signal in accordance with the determination, wherein the shift signal comprises at least one of an audible alert, a visual alert, an electric, or a wireless signal to an associated derailleur to change a current gear.

10. The method of claim 9, wherein generating the shift signal further comprises generating, via a shift indicator, an indication to change the current gear of the associated bicycle.

11. The method of claim 10, wherein the shift indicator provides at least one of the audible or visual alert indicative of a gear change.

12. The method of claim 9, wherein the associated derailleur is an electronic derailleur, further comprising:
wirelessly or electrically transmitting the shift signal to the associated derailleur; and
shifting, via the associated derailleur, a gear of the associated bicycle in accordance with the shift signal.

13. The method of claim 9, wherein the associated force sensor is a torque sensor communicatively coupled to the second microcontroller.

14. The method of claim 9, wherein cadence setting is received from an RPM setter communicatively coupled to the first microcontroller.

15. The method of claim 14, wherein RPM setter is selected from the group consisting of a display, a keypad, knob, throttle, lever, up-down (+/−) switch.

16. The method of claim 9, wherein the effort setting is received from an effort control communicatively coupled to the first microcontroller.

17. The method of claim 16, wherein the effort control is selected from the group consisting of a knob, a throttle, a lever, up-down (+/−) switch.

18. A method for controlling derailleur shifting on an associated bicycle, comprising:
receiving a cadence setting corresponding to a selected RPM into a first microcontroller;
receiving an effort setting corresponding to a selected force applied to a crank of the associated bicycle into the first microcontroller;
communicating, from an associated torque sensor to a second microcontroller communicatively coupled thereto, an amount of torque currently applied to the crank of the associated bicycle;
transmitting the current amount of torque from the second microcontroller to the first microcontroller;
calculating, from the current amount of torque, a cadence corresponding to a current RPM;
determining, in accordance with the current RPM and current amount of force by the first microcontroller, whether to generate a shift signal indicative of a gear change of the associated bicycle; and
generating, by the first microcontroller, the shift signal in accordance with the determination, wherein the shift signal comprises at least one of an audible alert, a visual alert, an electric or a wireless signal to an associated derailleur to change a current gear.

19. The method of claim 18, wherein calculating the cadence from the current amount of torque further comprises:
identifying a maximum and a minimum oscillation of torque output by the associated torque sensor;
measuring, via an internal clock of the second microcontroller, a time between peaks in the oscillation; and
detecting the cadence in accordance with measurements by the second microcontroller.

20. The method of claim 18, wherein the associated derailleur is an electronic derailleur, further comprising:
electrically or wirelessly transmitting the shift signal to the associated derailleur; and
shifting, via the associated derailleur, a gear of the associated bicycle in accordance with the shift signal.
